(19) United States
(12) Patent Application Publication
(10) Pub. No.: US 2002/0103833 A1
(43) Pub. Date: Aug. 1, 2002

(54) Electronic book kiosk

(76) Inventor: Travis Parry, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/771,153

(22) Filed: Jan. 26, 2001

(51) Int. Cl. G06F 17/30

(52) U.S. Cl. 707/526

(57) ABSTRACT

This invention relates to an electronic book (E-book) kiosk. Such structures of this type, generally, allow the user to select an E-book through the kiosk interface and download the E-book directly to the user's reader.

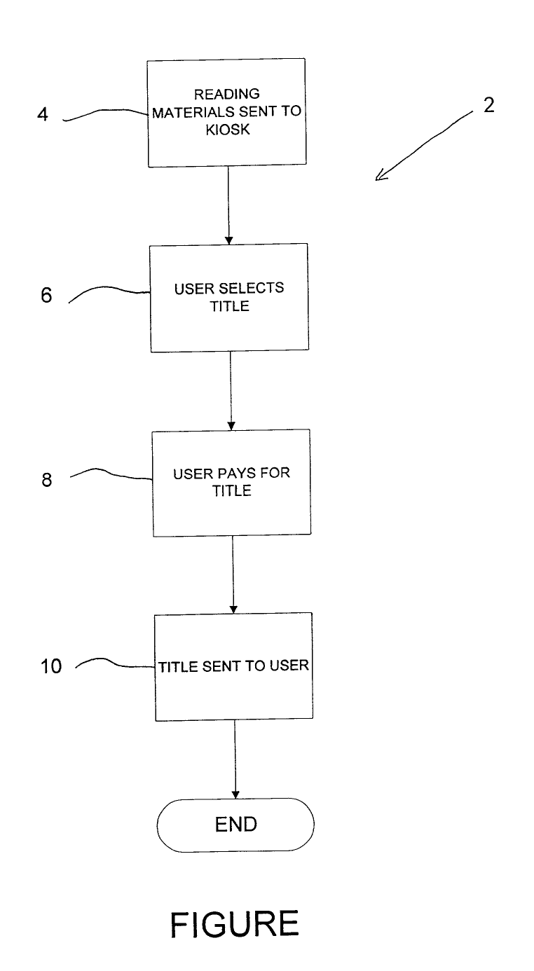

### FIELD OF THE INVENTION

This invention relates to an electronic book (E-book) kiosk. Such structures of this type, generally, allow the user to select an E-book through the kiosk interface and download the E-book directly to the user's reader.

### DESCRIPTION OF THE RELATED ART

It is known, in the publication and distribution of electronic reading materials, to employ an apparatus for viewing electronic reading materials. Exemplary of such prior art is U.S. Pat. No. 5,956,034 (′034) to J. Sachs et al., entitled “Method and Apparatus for Viewing Electronic Reading Materials.”While the ′034 reference employs an apparatus that contains an inventory of written materials in electronic form that can be selected and then downloaded into a portable electronic book memory, it does not disclose the use of the kiosk that allows the user to pay for the desired written materials and then download the materials to the user's personal communication device (PCD).

It is apparent from the above that there exists a need in the art for a kiosk, which is capable of downloading selected written materials in electronic form, but which at the same time allows for the user to pay for the downloaded written materials. It is a purpose of this invention to fulfill this and other needs in the art in a manner more apparent to the skilled artisan once given the following disclosure.

### SUMMARY OF THE INVENTION

Generally speaking, this invention fulfills these needs by providing a method for obtaining electronic reading materials, comprising the steps of: downloading electronic reading materials into a kiosk; selecting a desire reading material title; paying for the desired title; and downloading the desired title to the personal communication device.

In certain preferred embodiments, the reading materials can be downloaded into the kiosk either through the Internet or locally. Also, the user can pay an attendant at the kiosk or by electronic billing. Finally, the desired title is downloaded into the user's personal communication device (PCD) by squirting the desired title into the user's PCD.

In another further preferred embodiment, the kiosk allows the user to review available titles of electronic reading material, select the desired title, pay for the desired title, and downloaded the desired title into the user's PCD.

The preferred kiosk, according to this invention, offers the following advantages: ease-of-use; ability to view electronic reading materials; ability to select desired electronic reading materials; ability to pay for selected electronic reading materials; ability to download selected electronic reading materials; and good economy. In fact, in many of the preferred embodiments, these factors of ease-of-use, ability to view electronic reading materials, ability to select desired electronic reading materials, ability to pay for selected electronic reading materials, and ability to download selected electronic reading materials are optimized to the extent necessarily higher than heretofore achieved in prior, known kiosks.

The above and other features of the present invention, which will become more apparent as description proceeds, are best understood by considering the following detailed description in conjunction with the accompanying FIGURE and in which:

### BRIEF DESCRIPTION OF THE DRAWING

The FIGURE is a flow chart that illustrates a method for obtaining electronic reading materials, according to one embodiment of the present invention.

### DETAILED DESCRIPTION OF THE INVENTION

With reference to the FIGURE, there is illustrated one preferred embodiment for use of the concepts of this invention. In particular, method 2 for obtaining electronic reading materials at a kiosk is illustrated. With respect to method 2, reading materials are downloaded into a computer (not shown) located in or near the kiosk, as shown in step 4. It is to be understood that the term “kiosk” refers to, but is not limited to, a small, lightweight structure with one or more open sides. This “kiosk”, preferably, is located in an area of high people traffic, such as a mall, department store, airport or the like. With respect to step 4, electronic reading materials can be downloaded from the Internet and/or downloaded locally. The term “locally” refers to the instance where the owner of the kiosk can walk up to the kiosk and squirt electronic reading materials from his/her PCD into the computer located at or near the kiosk for further downloading by a user.

The user can browse through the variety of electronic reading material titles and select a title to be downloaded, as shown in step 6.

Once the user has selected a title to be downloaded, the user can then pay for the electronic reading materials to be downloaded, as shown in step 8. It is to be understood that the user can pay an attendant located at or near the kiosk or the user can pay for the desired electronic reading materials by electronic billing, such as through the use of a credit card/debit card reader located at or near the kiosk.

After the user has paid for the desired electronic reading materials to be downloaded, the desired electronic reading materials are downloaded or squirted to the user's personal communication device (PCD). A PCD can be, but is not limited to, a personal digital assistant (PDA) or the like which is wirelessly connected to a variety of Internet websites and/or the computer located at or near the kiosk. It is to be understood that the term “squirt” refers to the transmitting of a modulated carrier medium from the computer located at or near the kiosk to the user's PCD that is capable of detecting/reading a modulated carrier medium or vice versa. The carrier medium is modulated in such a way as to include computer executable instructions related to the desired electronic reading materials to be downloaded.

Once given the above disclosure, many other features, modifications or improvements will become apparent to the skilled artisan. Such features, modifications or improvements are, therefore, considered to be a part of this invention, the scope of which is to be determined by the following claims.

What is claimed is:

1. A method for obtaining electronic reading materials, wherein said method is comprised of the steps of:
downloading electronic reading materials into a kiosk;
selecting a desired reading material title;
paying for said desired title; and
downloading said desired title to a personal communication device (PCD).

2. The method, as in claim 1, wherein said step of downloading electronic reading materials into a kiosk is further comprised of the step of:
downloading electronic reading materials from the Internet.

3. The method, as in claim 1, wherein said step of downloading electronic reading materials into a kiosk is further comprised of the step of:
downloading electronic reading materials locally.

4. The method, as in claim 1, wherein said paying step is further comprised of the step of:
paying an attendant located substantially adjacent to said kiosk.

5. The method, as in claim 1, wherein said paying step is further comprised of the step of:
using electronic billing to pay for said desired title.

6. The method, as in claim 1, wherein said step of downloading said desired title is further comprised of the step of:
squirting said desired title from a computer located substantially adjacent to said kiosk to said PCD.

7. The method, as in claim 6, wherein said PCD is further comprised of:
a personal digital assistant (PDA).

8. A computer-readable medium having computer-executable instructions for the method recited in claim 1.

9. A program storage medium readable by a computer, tangibly embodying a program of instructions executable by said computer to perform method steps for obtaining electronic reading materials, said method steps comprising:
downloading electronic reading materials into a kiosk;
selecting a desired reading material title;
paying for said desired title; and
downloading said desired title to a personal communication device (PCD).
